(19) United States
(12) Patent Application Publication
(10) Pub. No.: US 2024/0311208 A1
(43) Pub. Date: Sep. 19, 2024

(54) VERIFYING A SECURITY AND COMPLIANCE STANDARD FROM A MULTI-CLOUD ARCHITECTURE DIAGRAM

(71) Applicant: International Business Machines Corporation, Armonk, NY (US)

(72) Inventors: Malarvizhi Kandasamy, Bangalore (IN); Sudheesh S. Kairali, Kakkanad (IN); Syed Shadab Warsi, Kolkata (IN)

(21) Appl. No.: 18/185,022

(22) Filed: Mar. 16, 2023

(51) Int. Cl. G06F 9/50

(52) U.S. Cl. CPC G06F 9/5077; G06F 9/5072

(57) ABSTRACT

Embodiments of the present invention provide an approach for verifying a security and compliance standard of a multi-cloud environment based on a multi-cloud architecture diagram. Specially, the multi-cloud architecture diagram is parsed to verify the security and compliance standard checks. A list of resources and relationships are extracted from the multi-cloud architecture diagram and compared against an expected security standard compliance level. Any resources attributing non-compliance of the expected compliance level are identified by comparing the list of resources and relationships from the multi-cloud architectural diagram in a recursive and continuous manner. Only when security and compliance standard checks are satisfied/passed are the cloud resources deployed.

### TECHNICAL FIELD

The present invention relates to cloud security compliance, and more specifically to embodiments for verifying a security and compliance standard of a multi-cloud environment based on a multi-cloud architecture diagram.

### BACKGROUND

When it comes to data storage, processing and collaboration, many businesses choose the flexibility and convenience of cloud computing over traditional local hosting and on-premises software. With cloud computing, you can access and store data and applications online instead of on a hard drive. Working in a cloud offers businesses many benefits, including enhanced collaboration, easy access and fast turnaround. However, cloud computing can involve legitimate security concerns. Cloud compliance frameworks help align data security policies and mitigate the risks of deploying third-party cloud infrastructure. Cloud compliance is the art and science of complying with regulatory standards of cloud usage in accordance with industry guidelines and local, national, and international laws. Some common regulatory requirements include the Health Insurance Portability and Accountability Act (HIPAA), Payment Card Industry Data Security Standard (PCI DSS), and Gramm-Leach-Bliley Act (GLBA).

### SUMMARY

Embodiments of the present invention provide an approach for verifying a security and compliance standard of a multi-cloud environment based on a multi-cloud architecture diagram. Specially, the multi-cloud architecture diagram is parsed to verify the security and compliance standard checks. A list of resources and relationships are extracted from the multi-cloud architecture diagram and compared against an expected security standard compliance level. Any resources attributing non-compliance of the expected compliance level are identified by comparing the list of resources and relationships from the multi-cloud architectural diagram in a recursive and continuous manner. Only when security and compliance standard checks are satisfied/passed are the cloud resources deployed.

A first aspect of the present invention provides a method for verifying a security standard compliance of a cloud resource, comprising: obtaining, by a processor, a multi-cloud architecture diagram representing the cloud resource configuration; extracting, by the processor, a list of resources and relationships from the multi-cloud architecture diagram; comparing, by the processor, each resource of the list of resources and relationships with an expected security standard compliance level; and identifying, by the processor, a resource attributing non-compliance of the expected security standard compliance level based on the comparison.

A second aspect of the present invention provides a computing system verifying a security standard compliance of a cloud resource configuration, comprising: a processor; a memory device coupled to the processor; and a computer readable storage device coupled to the processor, wherein the storage device contains program code executable by the processor via the memory device to implement a method, the method comprising: obtaining, by a processor, a multi-cloud architecture diagram representing the cloud resource configuration; extracting, by the processor, a list of resources and relationships from the multi-cloud architecture diagram; comparing, by the processor, each resource of the list of resources and relationships with an expected security standard compliance level; and identifying, by the processor, a resource attributing non-compliance of the expected security standard compliance level based on the comparison.

A third aspect of the present invention provides a computer program product for verifying a security standard compliance of a cloud resource configuration, the computer program product comprising a computer readable storage device, and program instructions stored on the computer readable storage device, to: obtain, by a processor, a multi-cloud architecture diagram representing the cloud resource configuration; extract, by the processor, a list of resources and relationships from the multi-cloud architecture diagram; compare, by the processor, each resource of the list of resources and relationships with an expected security standard compliance level; and identify, by the processor, a resource attributing non-compliance of the expected security standard compliance level based on the comparison.

### BRIEF DESCRIPTION OF THE DRAWINGS

FIG. 1 depicts a block diagram 100 illustrating an example of an environment for the execution of at least some of the computer code involved in performing the inventive methods, in accordance with embodiments of the present invention.

FIG. 2 depicts a block diagram 200 of a distributed system involved in performing the inventive methods, in accordance with embodiments of the present invention.

FIG. 3 depicts an example reference architecture 300 for virtual private cloud (VPC) with virtual servers for VPC, in accordance with embodiments of the present invention.

FIG. 4 depicts an example list of all resources 400 from an architectural diagram, in accordance with an embodiment of the present invention.

FIG. 5 depicts an example list of all relationships (relations) 500 from an architectural diagram, in accordance with an embodiment of the present invention.

FIG. 6 depicts an example flowchart 600 of a first method for verifying a security and compliance standard from a multi-cloud architecture diagram, in accordance with an embodiment of the present invention.

FIGS. 7A-C depicts example tables 700 showing a mapping of each resource and security controls pertaining to various compliance standards, in accordance with embodiments of the present invention.

FIG. 8 depicts a first example architecture diagram 800, in accordance with embodiments of the present invention.

FIG. 9 depicts example attributes 900 for resources of an architectural diagram, in accordance with embodiments of the present invention.

FIG. 10 depicts example additional details 1000 related to resources of an architectural diagram, in accordance with embodiments of the present invention.

FIG. 11 depicts a second example architecture diagram 1100, in accordance with embodiments of the present invention.

FIG. 12 depicts example simplified XML extracted with objects and edges connecting them along with parent information, according to embodiments of the present invention.

FIG. 13 depicts example code to verify whether a public gateway complies to a security compliance standard, according to embodiments of the present invention.

FIG. 14 depicts an example flowchart 1400 of a second method for verifying a security and compliance standard from a multi-cloud architecture diagram, in accordance with an embodiment of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

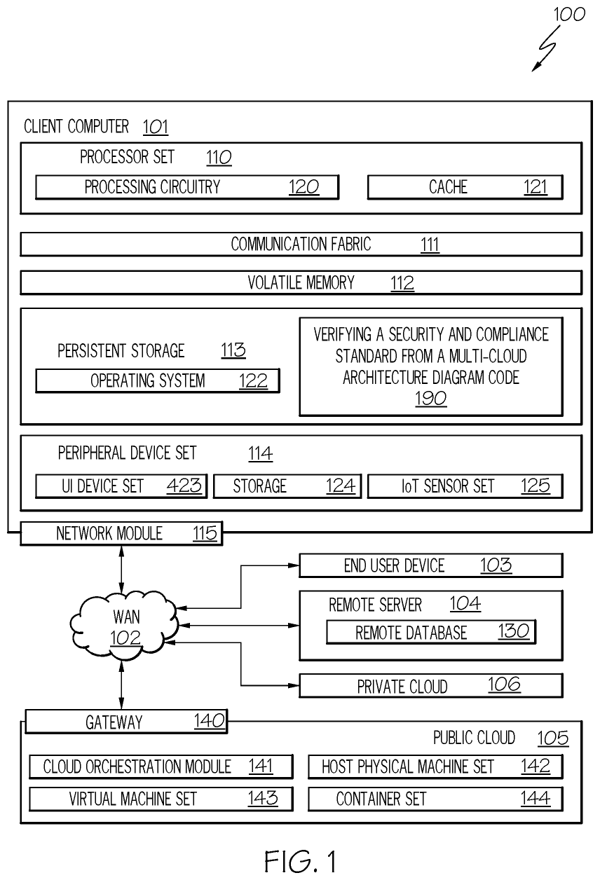

Computing environment 100 of FIG. 1 contains an example of an environment for the execution of at least some of the computer code involved in performing the inventive methods, such as exploring interesting data patterns in structured tables through verifying a security and compliance standard from a multi-cloud architecture diagram 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As cloud security adoption has increased, compliance standards have continued to evolve. Cloud platforms and services are expected to remain compliant with various international, federal, state, and local security standards, regulations, and laws. A lack of compliance to these rules can lead to legal challenges, penalties, fines, and other negative ramifications. Cloud compliance and security is more important than ever as the threat landscape becomes more sophisticated, and it is important should be proactively addressed. Part of the challenge of cloud compliance is that it exists on multiple levels, not all of which are controlled by the same parties. With the introduction of shadow information technology (IT), it becomes even more complex. Shadow IT is the use of information technology systems, devices, software, applications, and services without an explicit IT department approval.

Along with standard cloud provider compliance requirements, many large industries also have specific rules and regulations about cloud compliance. For example, the Payment Card Industry Data Security Standard (PCI DSS), which is used to ensure security for payments made with debit or credit cards, has specific requirements for cloud deployments. The same goes for the Health Insurance Portability and Accountability Act (HIPAA) in the healthcare industry. Many companies also impose user-side compliance. Just because a cloud service provider meets international standards and industry requirements, it doesn't automatically make the cloud service user compliant. A user still must ensure that the cloud service is used in a compliant manner, as well as the rest of the deployment.

Many cloud organizations want to be certified with these standards so that they can increase their ability to provide services to additional industry or region-specific customers. To be certified, services in a cloud have to get their service architecture reviewed with a chief information security officer (CISO) and her security team. Also, every service has a security focal whose job is to collect any evidence related to object storage, databases, regions, etc. A security focal is typically a person responsible for coordinating and disseminating safety and security updates and acting as an escalation point for local issues. Today, the security focal has to manually sit with an architect and collect all this evidence. Each compliance might have in excess of two hundred controls, and it is difficult for a security focal to remember to check all of them manually. As of today, a tool available doesn't exist that can say whether a service architecture adheres to a particular compliance standard (e.g., HIPAA) before implementation by looking at an architecture diagram. The proposed mechanism can provide an early idea whether an architecture is compliant to a particular standard or not and, if not compliant, a reason as to why the architecture is not standard compliant.

During the design and architecture stage itself, the proposed mechanism determines whether a service architecture is compliant or not so that a service can update (e.g., add, remove, configure) cloud resources and proceed with implementation with confidence with knowledge regarding compliance. It can avoid the last-minute surprises by knowing in advance the security and compliance correction. For example, during a network functions virtualization (NFV) implementation in a cloud network, a database might be found to be an incorrect type of database in order to be financial services (FS) cloud compliant. In that case, it might take several weeks to change the database and to correct and test any related program code. If this non-compliance was known in advance during an architecture and design stage, it would have resulted in a critical time and development effort savings.

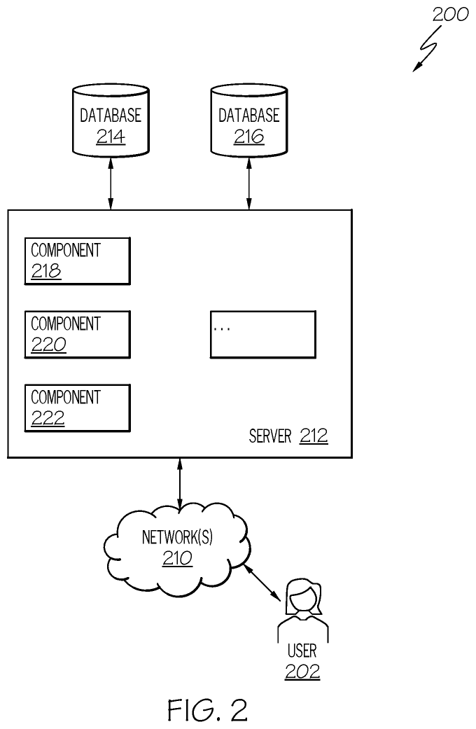

FIG. 2 depicts a block diagram of a distributed system 200 for implementing one or more of the embodiments. In the illustrated embodiment, distributed system 200 includes one or more users 202, who execute and operate a client application such as a web browser, proprietary client, or the like over one or more network(s) 210. Server 212 may be configured to communicate with user 202. In various embodiments, server 212 may be adapted to run one or more services or software applications provided by one or more of the components 218, 220, 222 of the system. In some embodiments, these services may be offered as web-based or cloud services or under a Software as a Service (SaaS) model to user 202.

In the configuration depicted in FIG. 2, the software components 218, 220, and 222 of system 200 are shown as being implemented on server 212. Users 202 may utilize one or more client applications to use the services provided by these components 218, 220, and 222. These components 218, 220, and 222 may be implemented in hardware, firmware, software, or combinations thereof. It should be appreciated that various different system configurations are possible, which may be different from distributed system 200. The embodiment shown in the figure is thus one example of a distributed system for implementing an embodiment system and is not intended to be limiting. Although exemplary distributed system 200 is shown with one user 202, any number of users may be supported.

Network(s) 210 in distributed system 200 may be any type of network familiar to those skilled in the art that can support data communications using any of a variety of commercially available protocols, including without limitation TCP/IP (transmission control protocol/Internet protocol), SNA (systems network architecture), IPX (Internet packet exchange), AppleTalk, and the like. For example, network(s) 210 can be a local area network (LAN), such as one based on Ethernet, Token-Ring and/or the like. Network(s) 210 can be a wide-area network and/or the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 212 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 212 may be adapted to run one or more services or software applications described in the foregoing disclosure. For example, server 212 may correspond to a server for performing processing described above according to an embodiment of the present disclosure.

In some implementations, server 212 may include one or more applications to analyze and consolidate data feeds and/or event updates received from user 202. As an example, data feeds and/or event updates may include, but are not limited to, real-time updates received from one or more third party information sources and/or continuous data streams, which may include real-time events related to sensor data applications, network performance measuring tools (e.g., network monitoring and traffic management applications), clickstream analysis tools, automobile traffic monitoring, and/or the like. Server 212 may also include one or more applications to display the data feeds and/or real-time events via one or more display devices of user 202.

Distributed system 200 may also include one or more databases 214 and 216. Databases 214 and 216 may reside in a variety of locations. In an example, one or more of databases 214 and 216 may reside on a non-transitory storage medium local to (and/or resident in) server 212. Alternatively, databases 214 and 216 may be remote from server 212 and in communication with server 212 via a network-based or dedicated connection. In one set of embodiments, databases 214 and 216 may reside in a storage-area network (SAN). Similarly, any necessary files for performing the functions attributed to server 212 may be stored locally on server 212 and/or remotely, as appropriate. In one set of embodiments, databases 214 and 216 may include relational databases that are adapted to store, update, and retrieve data in response to computing language commands.

The proposed mechanism seeks to leverage shift left cloud compliance. Shift left is the practice of moving testing, quality, and performance evaluation early in the development process, often before any code is written. Shift left testing helps teams anticipate changes that arise during the development process that can affect performance or other delivery processes. The security and compliance checks are verified for multi-cloud from an architecture diagram much before cloud resource deployment. The diagram is parsed to verify the security and compliance checks. Only when security and compliance checks are satisfied/passed are the cloud resources deployed. The methods of verifying and deploying cloud resources can be different. In the present disclosure, Infrastructure as Code (laC) for deploying cloud resources and Open Policy Agent (OPA) for policy verification are used. OPA is an open-source, general-purpose policy engine that decouples policy decisions from other application responsibilities.

The proposed solution provides a security/compliance check and verification using an architecture diagram of cloud services during the design prior to implementation. It uses the architecture diagram (or network diagram) which shows the list of all resources and how they are connected to each other using resource relationships (or relations). From that, a region, zone, backup, security rules, protocols, ports, and/or other details can be extracted. There are two methods (discussed in greater detail below) that can be used to verify security and compliance. The first method can review the architecture diagram and go through security control for each of the resources by checking each of the resources against a database/list and inform whether an architecture is a specific standard compliant or not.

With the second method, the diagram can be drawn with several attributes and values (metadata) provided by an architect. The architect needs to have only cloud domain knowledge (no-code/zero-code approach). The architect need not have security and compliance knowledge or implementation skills to know the compliance issues. Once the diagram is drawn, OPA rules are applied against the diagram and the diagram is converted to metadata JSON. After evaluating the cloud resources and its relations for security and compliance rules, the user is presented with the failing resources along with a failure reason for compliance correction. Also, the proposed mechanism can open issues (e.g., in GitHub) for failing compliance against each of the resources with a detailed failure reason and how the compliance failure can be corrected. GitHub is a website and cloud-based service that helps developers store and manage their code, as well as track and control changes to their code.

The proposed mechanism also suggests generation of missing cloud resources to make the architecture security standard compliant. Similarly, correction of cloud resources to make the architecture compliant can be done using this method. Configuration of necessary software in the cloud resources can be achieved to make the architecture compliant. Placement of resources in a multi-cloud architecture can be suggested by using this method. Also, the proposed mechanism can recommend other standards and security compliance which the current user can perform to make the system additional compliant by looking at a history of other users who have similar architecture diagrams. The advantages include a shift-left approach and a no-code/zero-code approach. Knowing the compliance issues in advance during design stage itself saves cost, time, efforts, zero skill sets, etc. It also avoids additional iterations for development and/or compliance teams. Further, it can also avoid manual error prone compliance verification.

During a security and compliance check audit, a security focal can present the architecture and the infrastructure diagram for the service to a Chief Information Security Officer (CISO). A security focal is a person responsible for coordinating and disseminating safety and security updates and acting as an escalation point for local issues. Typically, architects use a web-based interface (http://www.draw.io) to draw an architecture diagram for their cloud architecture. In draw.io, more details about resources like identifiers (IDs), tags, and links between resources can be added. The type of the resource can be added with tags like “ibm_ssh_key”, “ibm_vsi_instance”, etc. By using these tags, a resource list is populated. When two resources in draw.io are connected using a connector (i.e., “from” and “to”) then relationships are generated.

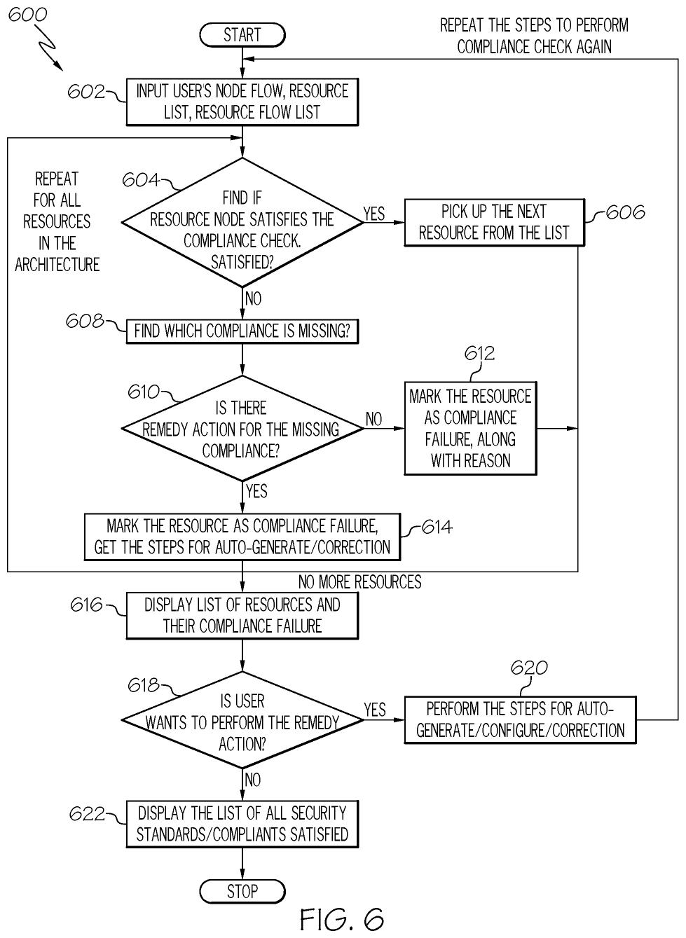

FIG. 6 depicts an example flowchart 600 for verifying a security and compliance standard from a multi-cloud architecture diagram. At 602, a node flow, resource list, and resource flow list are received as input. At 604, a determination is made whether a first resource node satisfies a compliance check. The following includes a list of example security compliance verification checks that can be performed from architecture diagram. From the architecture diagram, the proposed mechanism can detect: (a) whether there is a backup plan for critical resources like object storage (e.g., S3, Cloud Object Storage), database (e.g., Cloudant database, etcd database), global load balancer with origins pointing to different regions for backup; (b) the different regions where the backup is available; (c) whether there is a redundant resource for critical resources (e.g., Virtual Private Network gateway, Virtual Network Functions, Direct Link, Transit gateway, microservices with replicas, etc.); (d) in a multi-cloud environment, when there is an outage in a cloud and whether there is an alternate cloud that can serve customers; (e) whether there is a cloud monitoring solution like that keeps monitoring the Kubernetes (open-source container orchestration system) clusters and other cloud resources; (f) whether there is an agent like FIM (File Integrity Monitoring tool) that is monitoring virtual server instances; (g) whether there is security vulnerability scanner tools scanning the software images for security vulnerabilities; (h) whether there is an endpoint manager tool like BigFix that can scan and patch any security vulnerability issues (the tool can take care of the lifecycle management of the endpoints and fix the malware/viruses/spyware; a user can instantly patch all endpoints that require antivirus or scans); (i) whether there is a peer-to-peer connection that share file and block storage; (j) whether the code from a cloud is exposed outside using a public gateway, etc.; (k) whether there is a SSH key, certificates, IAM Authentication, API Key, etc.; (l) whether there is an Application Firewall (WAF) in place for DDOS Protection; and/or the like.

When a resource node is found to be compliant, at 606, the next cloud resource node is then checked for compliance (i.e., return to 602). Each resource node is checked one at a time until all the resource nodes are checked. If a resource node doesn't satisfy the compliance check, a determination is made as to which compliance is missing, at 408. At 610, a determination is made as to whether there is a remedy action for the missing compliance. If not, at 612, the resource is marked as a compliance failure, along with a reason for non-compliance. If a remedy action does exist, at 614, the resource is marked as a compliance failure and the remediation steps (e.g., steps for auto-generate, configure, correction, etc.) are gathered. At 616, a list of resources and any compliance failures are listed/presented to the user. For each compliance failure having a remedy action that exists, at 618, the user is asked whether she would like to perform the remedy action. If she does, at 620, the remediation steps are performed to make the resource compliant. At 622, a list of all compliance standards that are satisfied is listed/presented to the user.

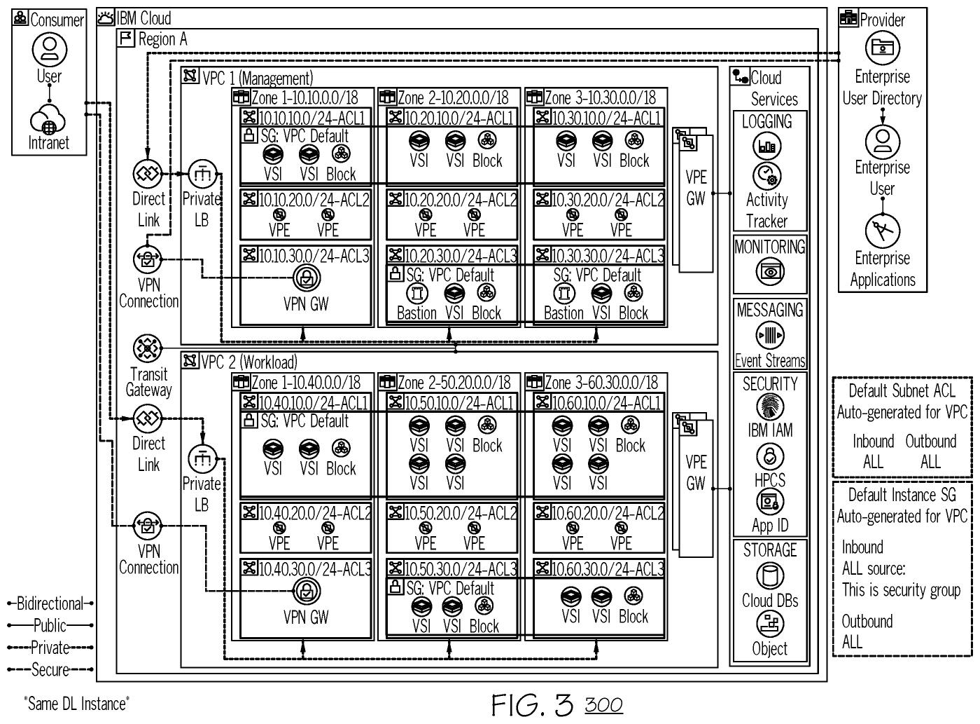

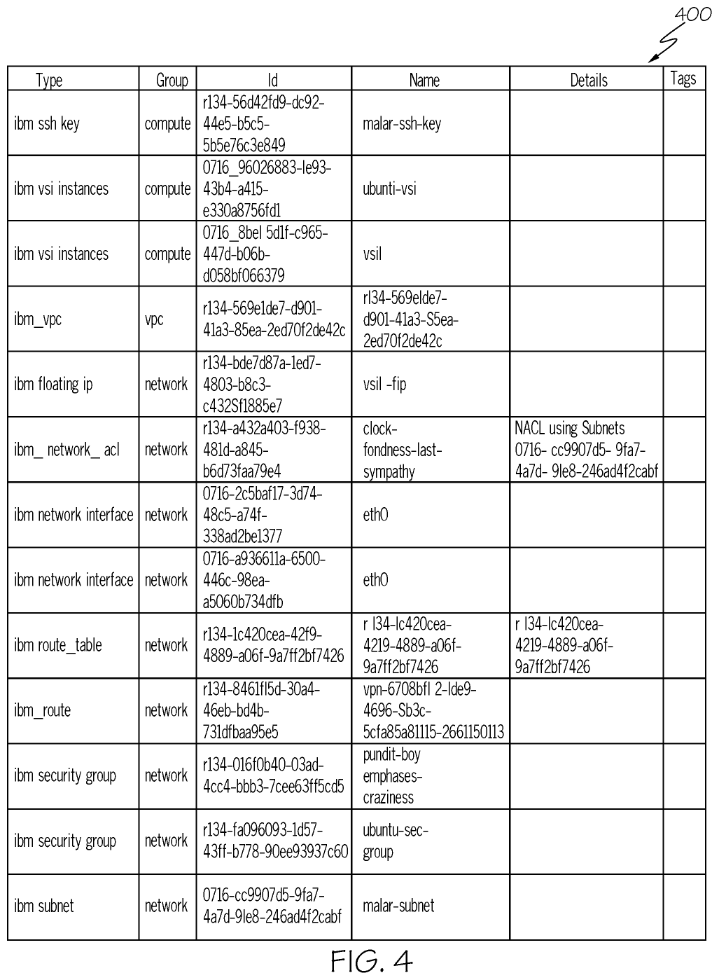

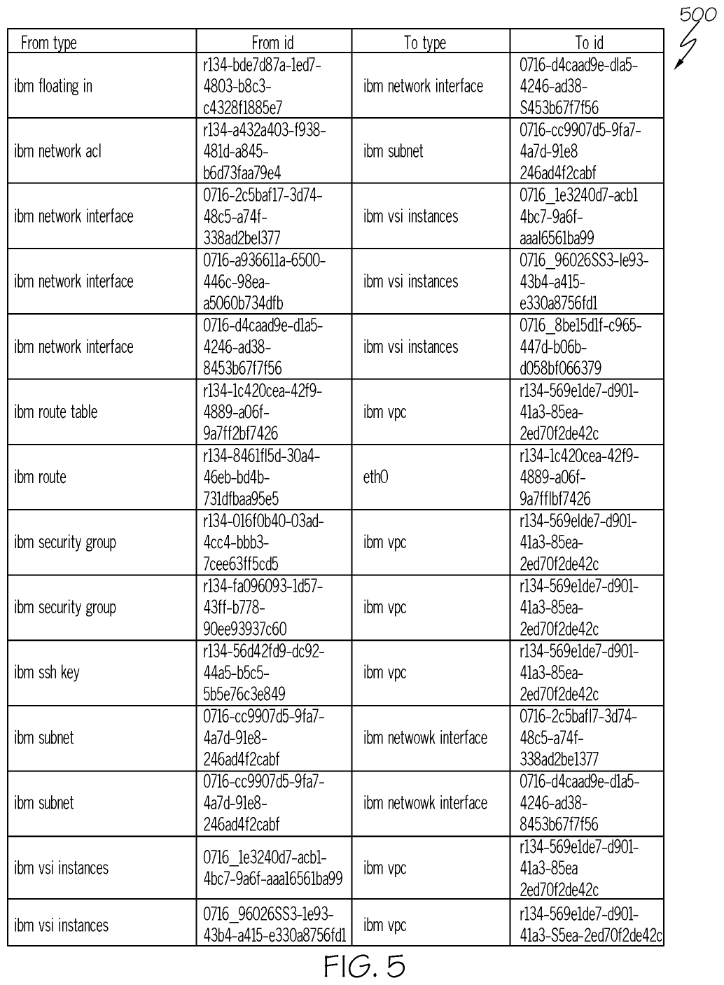

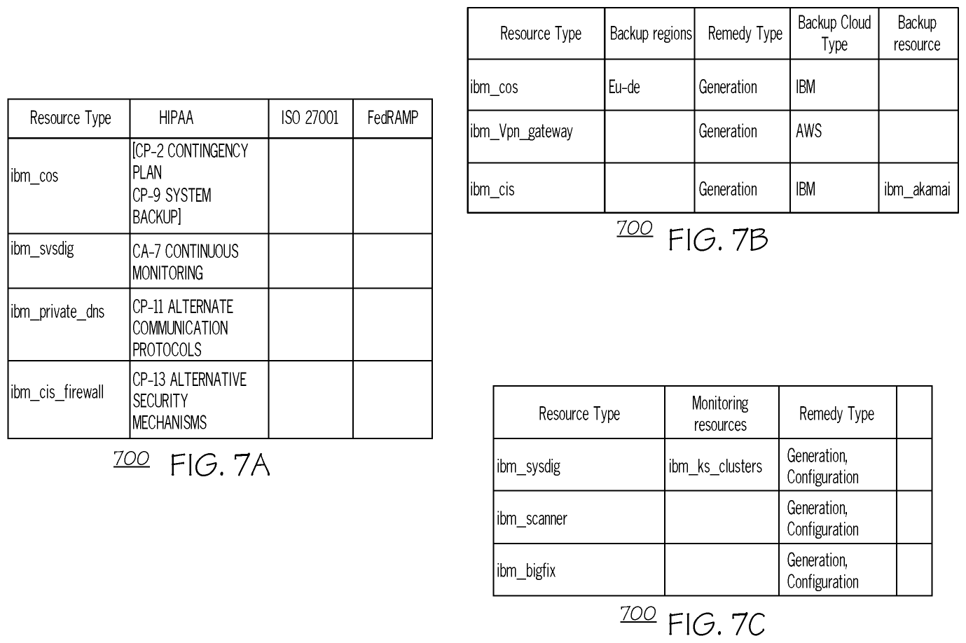

The first method for verifying security and compliance (described above) is described with reference to FIGS. 3-7C. FIG. 3 depicts an example reference architecture 300 for virtual private cloud (VPC) with virtual servers for VPC. From an architectural diagram, a list of resources and resource relationships can be generated. FIG. 4 depicts a list of all resources 400 from the architectural diagram shown in FIG. 3. FIG. 5 depicts a list of all relationships (relations) 500 from the same architectural diagram. For each of the resources, the security controls pertaining to various standards are mapped. FIGS. 7A-C depicts tables 700 showing a mapping of each resource and security controls pertaining to various compliance standards. As shown, for a HIPAA standard, certain security controls (e.g., CP-2 contingency plan, CP-9 system backup, CM-7(1) least functionality, CA-7 continuous monitoring, CP-13 alternative security mechanisms) need to be satisfied for the architecture to be HIPAA compliant. Similarly, other standards can be verified from an architecture diagram by referring the compliance standard from a JSON file or table and it can be certified as compliant or not. When a resource is not compliant and it is failing a particular check, a remedy type column is referred for each of the compliance failure and the corrective action whether the method should: (a) generate the cloud resources to make it particular standard compliant, (b) correct cloud resources, and/or (c) configure cloud resources.

A list of resources that requires auto generation, auto correction, and/or auto configuration can be displayed to a user and, if the user agrees, the resources are remedied, and the architecture is again corrected for security compliance. The resources and resource relations are modified with remedy action and the compliance check happens for new resource and resource relations. At the end, after the compliance verification, a new architecture diagram is generated for the remedied resources and resource relations and given to the user. The user can start implementation with this new architecture diagram.

In an embodiment, the proposed mechanism can generate a list of cloud resources. For example, assume cloud storage object does not have a backup plan in other regions. The other regions used by the service are found from an architecture diagram. The provisioning code of the service is then found (e.g., from a GitHub repository). The cloud storage object resource is can then found, and a similar resource is generated with the region changed to a backup region. Similarly, resources such as monitoring tools can be provisioned in cloud if the architecture is missing monitoring tools.

In an embodiment, the proposed mechanism can correct a cloud resource. For example, assume there is a VPC peer-to-peer (p2p) networking service in the cloud infrastructure where the p2p is not allowed. The proposed mechanism can suggest the user to destroy the resource. It also checks whether there are any unused resources, etc. If a resource doesn't have any resource relationships (or relations) then it is determined to be dangling resource and can be eliminated. Destroying of these resources are suggested to user. If user agrees to remove, the method removes those resources.

In an embodiment, the proposed mechanism can configure a cloud resource. For example, assume a virtual server instance is missing a file integrity monitoring tool (FIM) or it is not configured to run endpoint management software. In this instance, the proposed mechanism can suggest the configuration to install the necessary software, so that the systems are protected from security vulnerability threats. Similarly, by inputting the microservices architecture diagram, the proposed system can verify the security and compliance checks. For example, security control with Calico network policy can be verified whether there is “limited connectivity between micro services”. Calico network policies are a set of the Kubernetes network policies which manage network traffic on specific network interfaces. The system can verify a Calico network policy for domain name system (DNS) and check inbound/outbound traffic.

In another embodiment, a security compliance recommendation from a similar architecture diagram can be stored in a repository. Whenever a user submits an architecture diagram and verifies for security compliance, the resulting resources list, resource relations list and the various security compliance standards which the architecture is compliant are stored in history. Then, when a similar reference architecture is submitted for verification, the proposed system can suggest the user to make corrections similar to the reference architecture, so that the system will cover more security and compliance standards.

In addition, a placement and selection of cloud and its resources can assist in making an architecture security and standard compliant in a multi-cloud architecture. The proposed system can also maintain a list of all services in various clouds and the various standards that the service is compliant. Different cloud vendors like provide the same service but the services are different standards compliant. For example, DNS in ABC cloud is Federal Risk and Authorization Management Program (FedRAMP) compliant, but DNS (Domain Name System) in XYZ cloud vendor is not FedRAMP compliant. In a multi-cloud architecture, the system suggests from which cloud, the specific service needs to be added, in order to be specific standard compliant. For example, a user selects DNS from ABC cloud, S3 (Simple Storage Service) storage from XYZ cloud, and clusters from DEF cloud to be FedRAMP compliant.

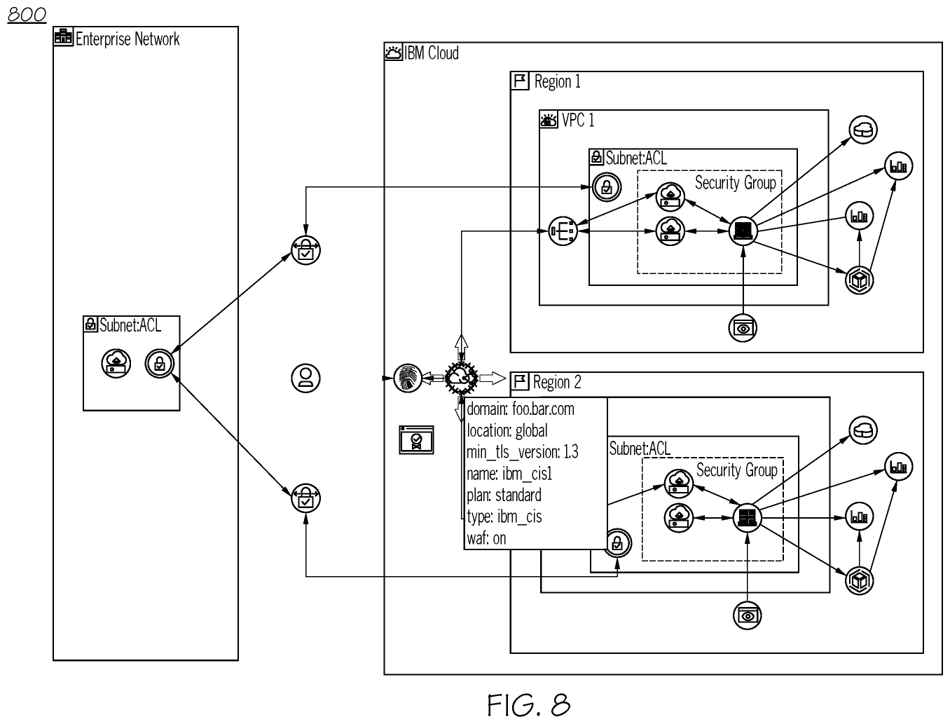

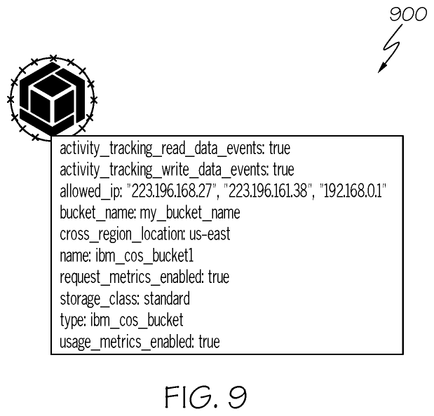

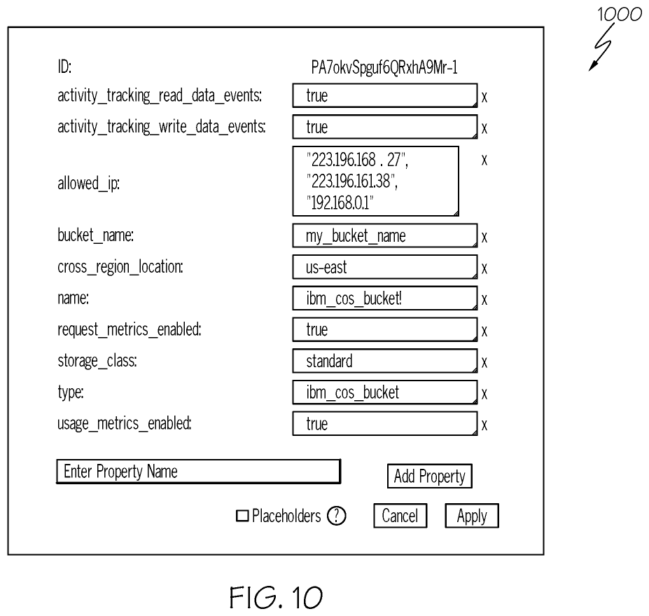

The second method for to verifying security and compliance (described above) is described below in greater detail with reference to FIGS. 8-12. The security and compliance can be verified during the design stage using OPA. During the early design stage, an architect or a user draws a cloud architecture diagram with his domain knowledge and fills the required attributes for every shape/object/resource as shown below. Majority of the architects use a web-based interface (http://www.draw.io) to draw architecture diagram for their cloud architecture. FIG. 8 shows a first example architecture diagram 800. Each resource in the diagram has some attributes defined for them. Some details of a resource are required to be provided by the user (e.g., a bucket name for a Cloud Object Storage bucket instance). Such attributes must be set by the architect during the design stage, in the diagram. FIG. 9 depicts attributes 900 for resources of architectural diagram 800. FIG. 10 depicts additional details 1000 related to resources of the same architectural diagram.

For all the shapes, a custom palette of resources along with mandatory attributes can be created and made available for cloud architects to create architecture diagram. A cloud architect can drag and drop the shape and fill the required attributes. Even the edges can be added to architecture with more details. In draw.io, more details about resources like an ID, tags, links between resources, etc. can be added. A type of the resource can be added (e.g., “ibm_is_vpn”, “ibm_is_vsi”, etc.). By using these attributes, a resource list is populated. When 2 resources in draw.io are connected using a connector, “from” and “to” relations are generated. The various properties of a resource like name, id, protocol, location, plan, type and others can be specified in shapes. The draw.io diagram can be exported as an XML file. When mxfiles (i.e., data file having an .mx extension) from draw.io are decoded and the xml file is converted to JSON, a resource graph can be constructed. From the JSON, list of all resources/objects and resource relations/edges can generated.

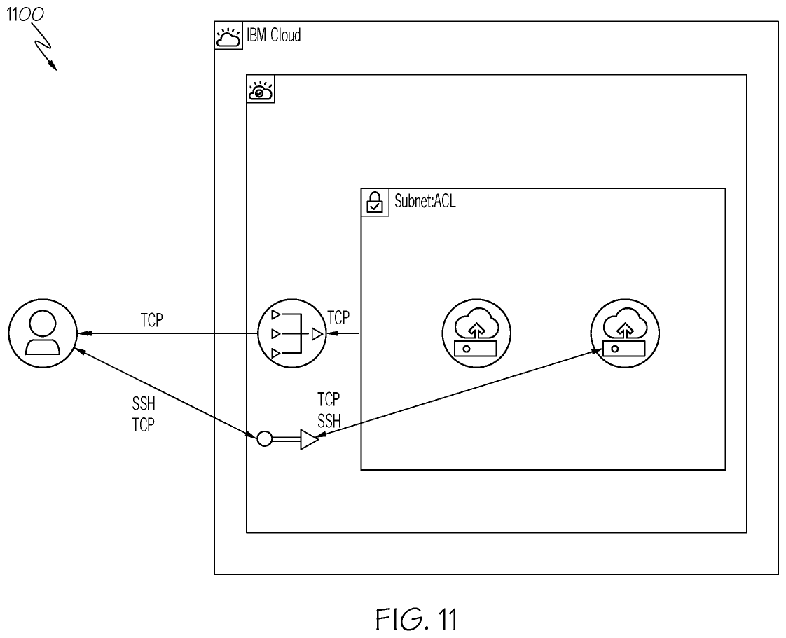

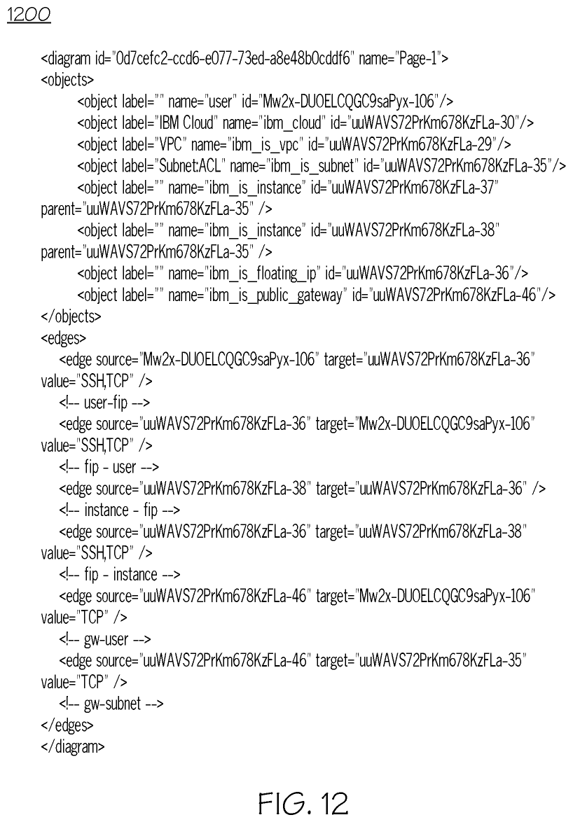

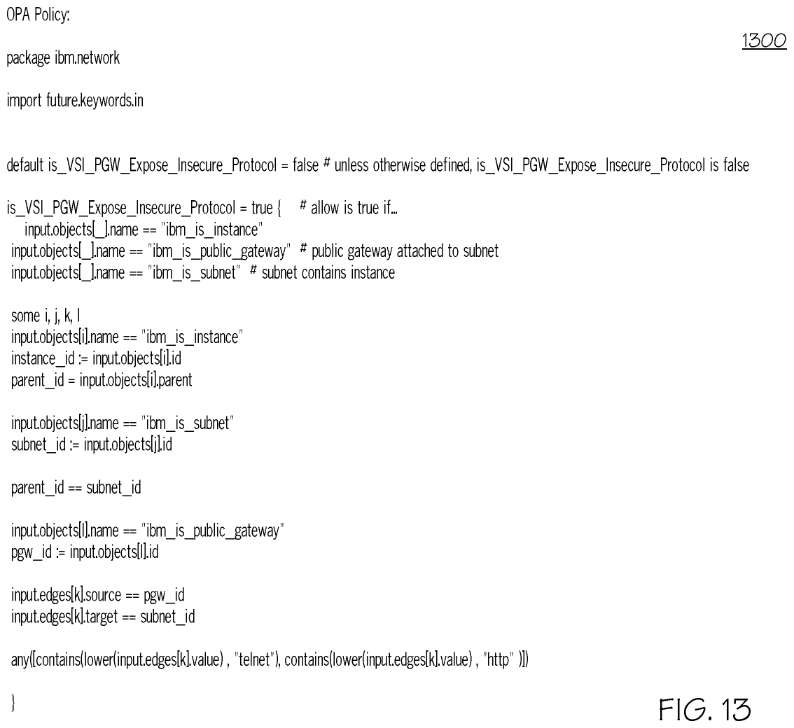

FIG. 11 depicts a second example architecture diagram 1100. From the draw.io diagram, below simplified XML can be extracted with objects and edges connecting them along with parent information, as shown in FIG. 12. A user can write an OPA code to verify security and compliance checks. OPA rules can be applied to diagram against simplified JSON. The code shown in FIG. 13 is used to verify whether a public gateway is attached to a subnet and is exposed to the Internet which is against the financial services (FS) cloud standard. If the public gateway is attached, it will be shown as noncompliant to the user. Similarly, the user can write various OPA policies against the simplified XML. Some of the security and compliance center goals include: (a) in CIS resource (ibm_cis), whether TLS version 1.2 or above is used; (b) in ibm_iam_account_settings, whether multi-factor authentication (MFA) is enabled; (c) whether a VPN gateway connection is using preshared_key of length at least 24 alphanumeric characters; (d) whether a subnet is exposed with a public gateway; (d) whether a VPC load balancer type should be private; (e) whether COS is enabled with activity tracking events; and/or the like.

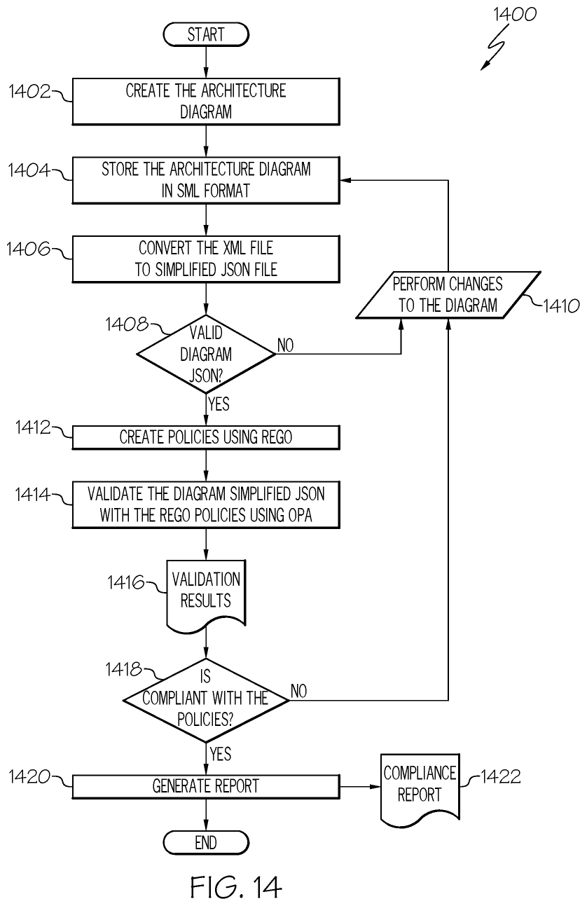

FIG. 14 depicts a flowchart diagram of a method for verifying a security and compliance standard from a multi-cloud architecture diagram. At 1402, an architectural diagram is created (e.g., using draw.io). At 1404, the proposed mechanism stores the architectural diagram in XML format. At 1406, the mechanism converts the XML file to a simplified JSON file. At 1408, a determination is made as to whether valid diagram JSON was generated. If not, at 1410, the user is notified to perform changes to the architectural diagram (e.g., return to 1404). If yes, a set of policies are created using Rego. OPA uses a high-level declarative language called Rego to describe policy. Rego makes it easy to build policy rules around hierarchical structured data, such as that represented in JSON or YAML, prevalent in many systems today. Having a purpose-built policy language allows policy to be described succinctly using primitives and built-ins tailor made for policy. At 1414, the diagram simplified JSON is validated with Rego policies using OPA. Validation results are generated at 1416. At 1418, a determination is made as to whether the architectural diagram (as represented by the simplified JSON) is compliant with the policies. If not, return to 1410. If yes, a compliance report is generated, at 1420. The compliance report is presented to the user, at 1422.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for verifying a security standard compliance of a cloud resource configuration, comprising:
obtaining, by a processor, a multi-cloud architecture diagram representing the cloud resource configuration;
extracting, by the processor, a list of resources and relationships from the multi-cloud architecture diagram;
comparing, by the processor, each resource of the list of resources and relationships with an expected security standard compliance level; and
identifying, by the processor, a resource attributing non-compliance of the expected security standard compliance level based on the comparison.

2. The method of claim 1, wherein the expected security standard compliance level is received from a centralized security and compliance standard repository.

3. The method of claim 1, further comprising recommending, by the processor, a new resource to replace the resource attributing non-compliance to make the cloud resource configuration security standard compliant by comparing the multi-cloud architectural diagram with a set of available reference security standard compliant multi-cloud architectures.

4. The method of claim 1, further comprising recommending, by the processor, a new cloud resource configuration to replace the cloud resource configuration to make the cloud resource configuration security standard compliant by comparing the multi-cloud architectural diagram with a set of available reference security standard compliant multi-cloud architectures.

5. The method of claim 1, further comprising, by the processor, automatically making at least one change to the cloud resource configuration and deploying the cloud resource with the changed configuration.

6. The method of claim 1, further comprising, by the processor, continuously monitoring for multi-cloud architecture diagram changes to identify a deviance of a security standard compliance level of a resource among the list of resources.

7. The method of claim 6, further comprising, by the processor, recommending a remedy to the resource to make the cloud resource configuration security standard compliant when the deviance of the security compliance level of the resource exists.

8. A computing system for verifying a security standard compliance of a cloud resource configuration, comprising:
a processor;
a memory device coupled to the processor; and
a computer readable storage device coupled to the processor, wherein the storage device contains program code executable by the processor via the memory device to implement a method, the method comprising:
obtaining, by a processor, a multi-cloud architecture diagram representing the cloud resource configuration;
extracting, by the processor, a list of resources and relationships from the multi-cloud architecture diagram;
comparing, by the processor, each resource of the list of resources and relationships with an expected security standard compliance level; and
identifying, by the processor, a resource attributing non-compliance of the expected security standard compliance level based on the comparison.

9. The computing system of claim 8, wherein the expected security standard compliance level is received from a centralized security and compliance standard repository.

10. The computing system of claim 8, further comprising recommending, by the processor, a new resource to replace the resource attributing non-compliance to make the cloud resource configuration security standard compliant by comparing the multi-cloud architectural diagram with a set of available reference security standard compliant multi-cloud architectures.

11. The computing system of claim 8, further comprising recommending, by the processor, a new cloud resource configuration to replace the cloud resource configuration to make the cloud resource configuration security standard compliant by comparing the multi-cloud architectural diagram with a set of available reference security standard compliant multi-cloud architectures.

12. The computing system of claim 8, further comprising, by the processor, automatically making at least one change to the cloud resource configuration and deploying the cloud resource with the changed configuration.

13. The computing system of claim 8, further comprising, by the processor, continuously monitoring for multi-cloud architecture diagram changes to identify a deviance of a security standard compliance level of a resource among the list of resources.

14. The computing system of claim 13, further comprising, by the processor, recommending a remedy to the resource to make the cloud resource configuration security standard compliant when the deviance of the security compliance level of the resource exists.

15. A computer program product for verifying a security standard compliance of a cloud resource configuration based on a multi-cloud architecture diagram, the computer program product comprising a computer readable storage device, and program instructions stored on the computer readable storage device, to:
receive, by a processor, the multi-cloud architecture diagram representing the cloud resource configuration;
extract, by the processor, a list of resources and relationships from the multi-cloud architecture diagram;
compare, by the processor, each resource of the list of resources and relationships with an expected security standard compliance level; and
identify, by the processor, a resource attributing non-compliance of the expected security standard compliance level based on the comparison.

16. The computer program product of claim 15, wherein the expected security standard compliance level is received from a centralized security and compliance standard repository.

17. The computer program product of claim 15, further comprising program instructions stored on the computer readable storage device to recommend, by the processor, a new resource to replace the resource attributing non-compliance to make the cloud resource configuration security standard compliant by comparing the multi-cloud architectural diagram with a set of available reference security standard compliant multi-cloud architectures.

18. The computer program product of claim 15, further comprising program instructions stored on the computer readable storage device to recommend, by the processor, a new cloud resource configuration to replace the cloud resource configuration to make the cloud resource configuration security standard compliant by comparing the multi-cloud architectural diagram with a set of available reference security standard compliant multi-cloud architectures.

19. The computer program product of claim 15, further comprising program instructions stored on the computer readable storage device to automatically make at least one change to the cloud resource configuration and deploy the cloud resource with the changed configuration.

20. The computer program product of claim 19, further comprising program instructions stored on the computer readable storage device continuously monitor, by the processor, for multi-cloud architecture diagram changes to identify a deviance of a security standard compliance level of a resource among the list of resources.
